(19) United States
(12) Patent Application Publication
(10) Pub. No.: US 2026/0170907 A1
(43) Pub. Date: Jun. 18, 2026

(54) ONLINE WAGER SYSTEM AND METHOD

(71) Applicant: Covered Technologies LLC, Glendale, CA (US)

(72) Inventors: Erick Garcia, Glendale, CA (US); Chad Tewksbury, Glendale, CA (US); Yidzak Ovando, Glendale, CA (US)

(21) Appl. No.: 19/405,008

(22) Filed: Dec. 1, 2025

Related U.S. Application Data
(63) Continuation of application No. 18/073,018, filed on Dec. 1, 2022, now abandoned.

(51) Int. Cl. G07F 17/32; H04L 51/046

(52) U.S. Cl. CPC G07F 17/3223; G07F 17/3281; G07F 17/3288; H04L 51/046

(57) ABSTRACT

An online wager system is provided that enables users to participate with one another in various types of wagers regarding various real-life events (e.g., regarding sporting events such as motocross racing). The system enables users to invite one another to participate in wagers through online messages and wager boards. The wagers are private and/or public and may involve wagers between a first user and a single second user and/or between a first user and a plurality of other users.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

This invention relates to systems and methods for placing wagers, including an online platform that enables its users to place wagers with one another via electronic invitations.

### BACKGROUND

Betting on sporting events through betting agencies is well known. Users wishing to place a bet may do so while given specific odds, and the bet is between themselves and the betting agency (often referred to as “the house”).

However, users are not able to place bets between one another, and/or between themselves and a plurality of other people interested in betting. In addition, users are not able to electronically send electronic invitations to other users inviting them to participate in one or more specific wagers, nor are users able to accept an invitation to a wager from within the electronic message.

Accordingly, there is a need for an online wager system that enables users to interface via electronic messages while placing bets with one another.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings are to scale unless specifically stated otherwise.

FIG. 1 shows an overview framework of an online wager system in accordance with exemplary embodiments hereof;

FIG. 2 shows aspects of an online wager system in accordance with exemplary embodiments hereof;

FIG. 3 shows aspects of an online wager system in accordance with exemplary embodiments hereof; and

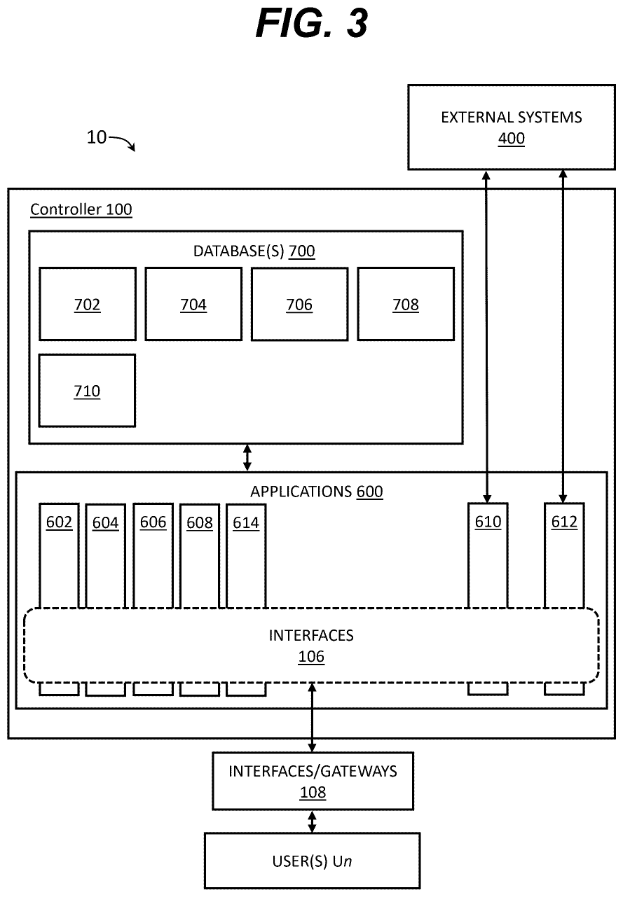

FIG. 4 depicts aspects of computing and computer devices in accordance with exemplary embodiments hereof.

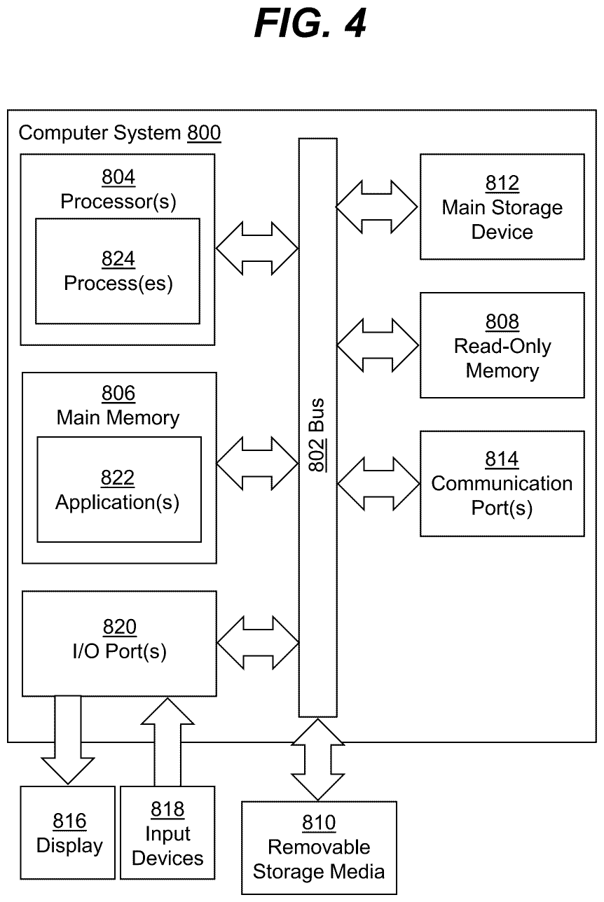

### DETAILED DESCRIPTION OF EXEMPLARY EMBODIMENTS

As used herein, unless used otherwise, the following terms and abbreviations have the following meanings:

A social network is a dedicated website system or other application which enables users to communicate with each other by posting information, comments, messages, images, etc.

Social contacts are nodes within a social graph (representing an individual or organization) to which another node is socially connected (e.g., through a social network). When individuals and/or organizations are connected through a social network, the individuals and/or organizations may communicate with one another through the social network.

A player is a person, entity, and/or thing performing an action (e.g., riding in a race) with a particular outcome upon which one or more users of the system may place a wager.

An event is a scenario (e.g., a sporting event) within which a player performs an action.

In general, and according to exemplary embodiments hereof, the online wager system 10 enables users Un to participate with one another in various types of wagers regarding various real-life events (e.g., regarding sporting events such as motocross racing). In addition, the system 10 enables users Un to place and/or participate in several different types of wagers as described herein.

For the purposes of this specification, the online wager system 10 will be described primarily with respect to its use in enabling wagers to be placed by users Un in relation to the motocross racing sporting industry. However, it is understood that the online wager system 10 may be implemented for any type(s) of event(s), and that the scope of the system 10 is not limited in any way by the type(s) of event(s) and/or industries that it may be used with.

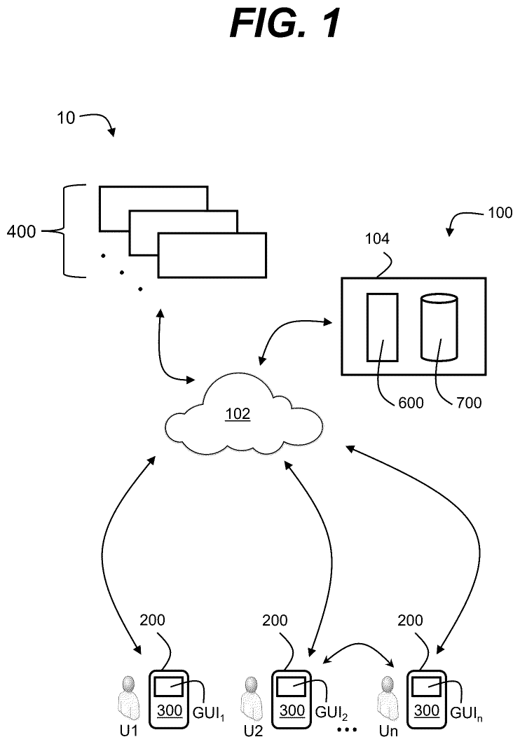

FIG. 1 shows an overview of an exemplary framework for an online wager system 10 according to exemplary embodiments hereof. As shown, the online wager system 10 (also referred to herein as simply the system 10) includes a cloud platform 100 (also referred to as a backend system, backend, or controller) accessible through a network 102 such as the Internet, LAN, WAN, wireless communication systems, cellular communication systems, telephony or other types of communication systems or protocols. As will be described in other sections, the backend system 100 includes one or more servers 104 with one or more software systems 106 including one or more applications 600 and one or more databases 700. The one or more software systems 106 may include operating systems, system software, web server software, social networking software, communication software, software applications, scripts, firmware, other types of software systems and any combinations thereof.

The system 10 is accessed by multiple users U0, U1, U2 . . . Un (e.g., via the network 102) using one or more applications 300 (e.g., a mobile application or “app”, a browser, and/or other type(s) of applications) running on one or more computing devices 200 (e.g., client devices such as smart phones, tablet computers, laptop computers, desktop computers, mobile media players, etc.). The system 10 also may interface with various external entities and/or systems 400 such as professional and/or amateur sporting leagues and associations, sport betting agencies, news agencies, other external systems, and any combinations thereof.

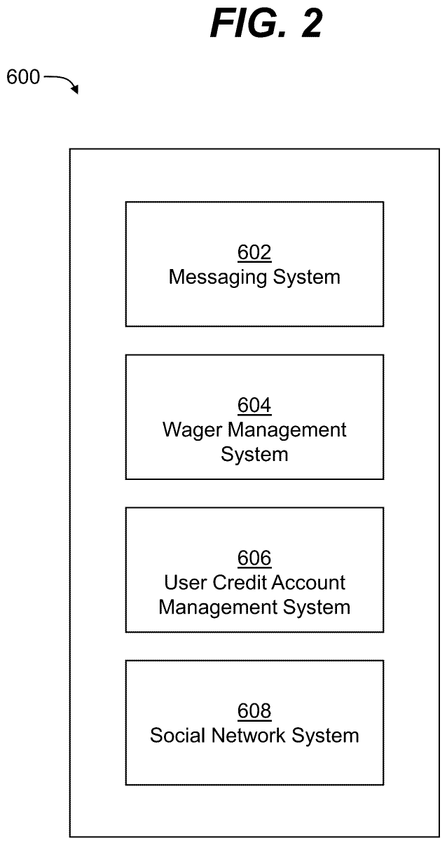

In some embodiments, as shown in FIG. 2, the one or more applications 600 include a messaging system 602, a wager management system 604, a user system credit account management system 606, and/or other applications as necessary.

In some embodiments, the messaging system 602 provides functionality that enables users Un to make public posts on his/her feed and/or timeline, to make private posts on his/her feed and/or timeline, to make public posts on other users' feed(s) and/or timeline(s), to make private posts on other users' feed(s) and/or timeline(s), to comment on posted messages, to like posted messages, to share posted messages with other users Un, to reply to messages, to forward messages, to post messages on a message board, to post comment(s) on other messages on a message board, to otherwise interact with other users Un through the messaging system 602, and any combinations thereof. In some embodiments, the messaging system 602 provides functionality that enables users Un to interface with one another via chat messaging, email, text messaging, voice messaging, other types of messaging, and any combinations thereof. It is understood that the messaging system 602 enables a first user U1 and a second user U2 to communicate with one another via any types of messages. In other embodiments, the messaging system 602 enables a plurality of users Un to communicate with one another together (e.g., in a group message board, group chat, group email, group text, etc.) via any types of messages enabled by the messaging system 602 as described herein or otherwise.

For the purposes of this specification, the term message will refer to any communication between any users Un through use of the system 10. As such, a message may include a new message, a reply to a message, a comment made to a message, a shared message, a forwarded message, any other type of message between any number of users Un, and any combinations thereof.

In some embodiments, as shown in FIG. 2, the system 10 may include one or more social network systems 608. In this way, multiple users Un may interact with one another (with his/her social contacts) through the social network(s) 608 as they interact with the system 10. However, it is understood that this may not be necessary and that the system 10 may include any type of platform(s) that enables users Un to interface with one another and with the system 10.

In some embodiments, the system 10 may include an interface, such as a website and/or any other type of interface, that may include at least some of the elements (e.g., webpages) including, but not limited to:
1. A wager-board that displays available system wagers (e.g., invitations by one or more users Un to participate in a wager), wagers placed, wager status (open or closed), wager payout, and other types of information regarding wagers placed with the system 10;
2. A wager information section for each user Un that displays the respective user's Un's placed wagers, pending wagers, won wagers, lost wagers, earnings, losses, other information regarding the user's wager history, etc.;
3. A wager placement section that allows users Un to create wagers as described herein;
4. A user system credit account section for each user Un that shows information regarding the respective user's system credit account information such as total account balance, credits held within a holding account, pending payments, pending payouts, balance history, etc. This section also may enable the user Un to add additional funds into his/her account, to withdraw funds from his/her account, view account transcripts, etc.;
5. A user profile and settings section for each user Un showing the respective user's profile and system settings, including an ability to edit the same, and
6. Other sections.

### Individual Wagers and Spider Wagers

In some embodiments, the system 10 includes functionalities that enable its users Un to place and/or participate in individual wagers and/or in spider wagers.

In some embodiments, as shown in FIG. D, individual wagers enable a first user U1 to enter into a wager with one other user Un only (e.g., with one second user U2). In this type of wager, only the first and second users U1, U2 participate in the wager.

In some embodiments, as shown in FIG. S, spider wagers enable a first user U1 to enter into a wager with one or more other users Un. In this type of wager, the first user U1 may enter into the same wager with a plurality of other users Un such that the first user U1 and the plurality of other users Un may all participate in the wager together. In this type of wager, the first user U1 has the same wager with each of the other users Un, and each of the other users Un have the same wager with the first user U1. However, none of the other users Un have the particular wager with each other.

In some embodiments, when setting up a spider wager, a user Un may define a maximum number of spider wager slots (e.g., ten) such that only this number of other users Un may potentially accept the spider wager. Also, in some embodiments, if less than the maximum number of spider wager slots end up being accepted, the spider wager may continue between the user Un and the number of other accepted users Un. In other embodiments, it may be required that all spider wager slots be accepted in order for the wager to be placed.

In some embodiments, in any of the types of wagers described herein or otherwise, open wagers may include a time limit after which the wager may close. For example, wagers may close at a predefined amount of time prior to the event that the wager is based on, e.g., wagers may close one hour prior to the start of a particular wagered event. In some embodiments, if one or more other users Un have accepted the wager prior to its closing, then the wager is placed. If, however, no other users Un have accepted the wager prior to its closing, the wager is not placed and is cancelled.

### Private Wagers and Public Wagers

In some embodiments, the system 10 provides functionalities that enable its users Un to place and/or participate in different types of system wagers. For example, in some embodiments, the system 10 enables its users Un to participate in private wagers and/or in public wagers.

In some embodiments, private wagers include wagers wherein a particular user Un invites one or more particular other users Un through the system 10 to participate in one or more wagers. In some embodiments, private wagers may be initiated through the use of the system's 10's messaging functionalities wherein a user Un may send wager invitations as and/or included in messages to one or more of his/her contacts within the system 10.

For example, in some embodiments, a first user U1 may send a message through the system 10 to a second user U2 with an invitation to participate in an individual wager. Being an individual wager, only the second user U2 is invited to participate in the wager and if accepted, the wager is only between the first user U1 and the second user U2. On the other hand, if the wager is a spider wager, the first user U1 may send the message to a plurality of other users Un (e.g., to ten different users Un) and any of the users Un that accept the wager will participate in the wager with the first user U1. Notably, not all of the invited users Un are required to accept the wager for the wager to be placed by the system 10 (e.g., only one or more of the invited users Un are required to accept the wager for the wager to be placed).

In some embodiments, the wager invitation message that the first user U1 may send may include a new message initiated by the first user U1, a comment that the first user U1 adds to a prior message (e.g., a comment reply to a message originally sent by a second user U2), any other type of message enabled by the system 10, and any combinations thereof.

The message that the first user U1 may send to the other users Un (whether an individual wager or a spider wager) may include information regarding the wager such as, but not limited to, the username of the first user U1, the type of wager (e.g., 1 to 1 wagers or placement wagers as will be described in other sections), amount of the wager, players involved, placement of the player(s) wagered, event name, date of the event, time left to place the wager, event and wager results release date, usernames of the users Un who have accepted the wager, other information, and any combinations thereof.

In some embodiments, the message may include a first selectable user interface element (e.g., a button or link) that the receiving user(s) (e.g., the second user U2 and/or the plurality of other users Un in the examples above) may click or otherwise activate to accept and participate in the wager. Once accepted, the system 10 may confirm the wager with each of the users Un, and upon confirmation, the system 10 may implement the wager for all of the participating users Un.

In some embodiments, when a user Un activates the first selectable user interface element to accept the wager, the system 10 may redirect the user Un to an additional dialogue (e.g., a webpage) that includes information regarding the wager as well as a secondary selectable user interface element (e.g., a button or link) that serves as a secondary confirmation that the user Un agrees to the terms of the wager and that the user Un is indeed placing the particular wager. Once the secondary selectable user interface is activated (e.g., clicked) the system 10 may confirm and place the wager.

In some embodiments, once a wager invitation (e.g., to an individual wager or spider wager) is accepted by the invitee user(s) Un, the system 10 may close the wager such that other users Un may not join the wager. However, if the wager invitation was included in a public message (e.g., in a public post on a user's timeline or feed) that other users Un may view, other users Un who wish to participate in an identical, similar, or otherwise new wager may do so by commenting on the wager invitation post. For example, in some embodiments, the system 10 may provide a “Create Wager” selectable user interface element within a comment section of the messaging system 602 that when selected enables the other users Un to create new wager invitations that other users Un viewing the comment may accept. This in turn may enable the other users Un to invite, accept, and otherwise participate in wagers as described herein.

Public wagers on the other hand include public postings of wagers within the system 10 (e.g., on a public wager-board or listing) wherein any other users Un who view the posted wagers may participate in the wagers if interested. For example, in some embodiments, the system 10 includes a wager-board dialogue (e.g., a webpage) that displays one or more lists of public wagers created by one or more users Un of the system 10. The wager-board may display information regarding each of the wagers, such as, but not limited to, the username of the user Un who posted the public wager, the type of wager (e.g., 1 to 1 wagers or placement wagers as will be described in other sections), amount of the wager, players involved, placement of the player(s) wagered, event name, date of the event, time left to place the wager, event and wager results release date, usernames of the users Un who have accepted the wager, other information, and any combinations thereof. In some embodiments, the wagers may be color-coded depending on the status of the wager, e.g., green for wagers that are still open to accept, red for closed wagers, etc.

In some embodiments, the wager-board also includes one or more selectable user interface elements (e.g., buttons or links) associated with each of the public wagers listed that users Un interested in participating may click. When clicked, the system 10 may direct the interested user Un to a new dialogue (e.g., webpage) that includes information regarding the wager as well as a secondary selectable user interface element (e.g., a button or link) that serves as a secondary confirmation that the user Un agrees to the terms of the wager and that the user Un is indeed placing the particular wager. Once the secondary selectable user interface is activated (e.g., clicked) the system 10 may confirm and place the wager.

In some embodiments, as shown in FIG. W, the system 10 provides functionalities that enable its users Un to place and/or participate in different types of event wagers. For example, in some embodiments, the system 10 enables users Un to participate in (i) 1 to 1 wagers, (ii) placement wagers, and (iii) other types of wagers.

### 1 to 1 Wagers

In some embodiments, the system 10 enables its users Un to place and/or participate in 1 to 1 wagers wherein a bet is made as to whether a particular first player will place higher in a particular event than a particular second player. The 1 to 1 wagers may be placed as private wagers and/or public wagers. For example, as a private wager, a first user U1 may place a 1 to 1 wager with a second user U2 that Player1 will place higher than Player2 in a particular race. If Player1 places higher than Player2 in the race, the first user U1 wins the bet and the system 10 deducts the wagered amount from the second user's U2's system account and places it into the first user's U1's system account. However, if Player1 places equal to or below Player2 in the race, the second user U2 wins the bet and the system 10 deducts the wagered amount from the first user's U1's system account and places it into the second user's U2's account.

In a second example, as a spider wager, the first user U1 may invite a plurality of other users Un to participate in a wager as to whether a particular first player (e.g., Player1) will place higher in a particular event than a particular second player (e.g., Player1). If Player1 places higher than Player 2, the first user U1 wins the bet and the system 10 deducts the wagered amount from each of the system accounts of each of the other users Un who accepted the wager and places the entire amount into the first user's U1's system account. In this scenario, the first user U1 wins an amount equal to the wagered amount multiplied by the number of other users Un who participated in the spider wager. However, if Player1 places equal to or below Player2 in the race, the other users Un win the bet and the system 10 deducts the wagered amount multiplied by the number of participating other users Un from the first user's U1's system account and places a wagered amount into each of the other participating user's Un's system accounts. In this scenario, the first user U1 loses an amount equal to the wagered amount multiplied by the number of other users Un who participated in the spider wager, and each of the other users Un each win an amount equal to the wager amount.

### Placement Wagers

In some embodiments, the system 10 enables its users Un to place and/or participate in placement wagers wherein a bet is made as to whether a particular player will place higher, lower, or exactly in a particular place in a particular event. For example, a first user U1 may place a placement wager with a second user U2 that Player1 will place in third place or higher in a particular race. If the Player1 places in third place or higher (e.g., in third, second, or first place), the first user U1 wins the bet and the system 10 deducts the wagered amount from the second user's U2's system account and places it into the first user's U1's account. However, if Player1 places below third place in the race (e.g., in fourth, fifth, sixth, seventh place, etc.), the second user U2 wins the bet and the system 10 deducts the wagered amount from the first user's U1's system account and places it into the second user's U2's account.

In a second example, as a spider wager, a first user U1 may place a placement wager with a plurality of other users Un that Player1 will place in third place or higher in a particular race. If the Player1 places in third place or higher (e.g., in third, second, or first place), the first user U1 wins the bet and the system 10 deducts the wagered amount from each of the other user's Un's system account and places the entire amount into the first user's U1's account. However, if Player1 places below third place in the race (e.g., in fourth, fifth, sixth, seventh place, etc.), the other users Un win the bet and the system 10 deducts the wagered amount multiplied by the number of participating other users Un from the first user's U1's system account and places a wagered amount into each of the other participating user's Un's system accounts. In this scenario, the first user U1 loses an amount equal to the wagered amount multiplied by the number of other users Un who participated in the spider wager, and each of the other users Un each win an amount equal to the wager amount.

### User System Credit Accounts

In some embodiments, the system 10 includes functionalities that enables users Un to transfer currency (e.g., US dollars and/or other currency) into his/her system credit account to be used to place on wagers. For example, the system 10 may enable a user Un to transfer currency directly from his/her outside bank account (e.g., using a debit card, check, wire, direct deposit, PayPal®, etc.) into his/her system account, to transfer currency from his/her credit card into his/her system account, to send a check or money order to the system 10 to be placed into his/her system account, to otherwise provide currency to the system 10 to be placed into his/her system account, and any combinations thereof. The system 10 may accept any type of legitimate currency, including, but not limited to, US currency, Canadian currency, Mexican currency, European currency, currency from any other countries, crypto currency (e.g., Bitcoin), other types of currency, and any combinations thereof.

In some embodiments, upon receiving a deposit from a user Un into his/her system account, the wager management system 604 and/or the user system credit account management system 606 may convert the deposited currency into an equivalent value of system credits. In some embodiments, the system 10 includes a predefined conversion rate(s) that it may use to convert the deposited currency into system credits, using different rates for different currencies as appropriate.

In some embodiments, when a user Un is placing a wager, the system 10 may first check to confirm that the user Un have an amount of currency in his/her user system credit account equal to or greater than the amount of the proposed wager. Then, when the wager is placed, the system 10 may deduct the amount of the proposed wager from the user's system credit account and place it into a holding account. In this way, the system 10 ensures that if the user Un loses the wager, any potential payout to other user(s) Un may be covered by the holding account credits. For example, if a first user U1 wishes to place an individual wager with a second user U2, the system 10 may first check to confirm that the first user U1 have a number of credits equal to or greater than the wager amount in his/her system account, and upon confirmation of this, may transfer an amount of credits equal to the wager amount from the first user's account and place it into the holding account. In another example, if the user Un wishes to place a spider wager between himself/herself and up to ten other users Un, the system 10 may confirm that the user Un has enough credits to cover the wager amount multiplied by the number of invited users Un, and upon confirmation of this, may transfer the amount of the wager multiplied by the number of potential other users Un (in this example, ten) from the user's Un's system credit account into the holding account for the placement of the wager. If, however, less than the potential number of other users Un accept the spider wager (in this example, say only six of the potential ten other users Un accept the spider wager), the system 10 may transfer an amount equal to the number of unused spider wager slots multiplied by the amount of the wager back into the user's Un's system credit account. In this way, only the amount of the wager(s) that the user Un may end up being accountable for is held in the holding account.

Similarly, for users Un accepting wagers, the system 10 checks and confirms that each accepting user Un also has enough credits within his/her system credit account to cover the wager that he/she intends to participate in. Then, the amount of the wager that they may accept is transferred from his/her account into the holding account to cover the wager.

In any of these scenarios, once the event results have been announced and/or received by the system 10, the system 10 may notify the users Un of the results of the wager(s) and pay the winners from the holding account to cover the wagered amounts plus the winnings. For example, if the first user U1 from the above example wins the wager against the second user U2, the credits deducted from the first user's account to cover the wager are returned to his/her account and the system 10 additionally transfers the wagered credits from the second user U2 (the credits deducted from the second user's account and placed into the holding account) into his/her account as winnings. Accordingly, in some embodiments, the system 10 may transfer an amount of credits equal to twice the wagered amount into the winner's account from the holding account. Following the second example above, if the user Un wins a spider wager, the system 10 returns the amount of credits deducted from his/her account to cover the spider wager and additionally transfers an amount equal to the wagered amount multiplied by the number of other users Un who participated in the spider wager into his/her account. If, however, the first user U1 loses the wager, the system 10 returns the deducted amounts of credits to each of the respective other users Un and additionally pays each of the participating other users Un an amount equal to the wagered amount from the holding account.

In some embodiments, the system 10 may deduct a transaction fee (e.g., 1%) from the winnings to cover use of the system 10.

### System Structure

FIG. 10 shows aspects of an exemplary project development system 10 of FIG. 1. As shown, the system 10 and backend system 100 comprises various internal applications 600 and one or more databases 700, described in greater detail below. The internal applications 600 may generally interact with the one or more databases 700 and the data stored therein.

The database(s) 700 may comprise one or more separate or integrated databases, at least some of which may be distributed. The database(s) 700 may be implemented in any manner, and, when made up of more than one database, the various databases need not all be implemented in the same way. It should be appreciated that the system is not limited by the nature or location of database(s) 700 or by the manner in which they are implemented.

Each of the internal applications 600 may provide one or more services via an appropriate interface. Although shown as separate applications 600 for the sake of this description, it is appreciated that some or all of the various applications 600 may be combined. The various applications 600 may be implemented in any manner and need not all be implemented in the same way (e.g., using the same software languages, interfaces, or protocols).

In some embodiments, the applications 600 may include one or more of the following applications 600:
1. Messaging System application(s) 602. This application 602 provides all of the functionalities associated with the system messaging system as described herein.
2. Wager Management System application(s) 604. This application 604 provides all of the functionalities associated with enabling one or more users Un to place, accept, and/or otherwise participate in any wagers associated with the system 10.
3. User System Credit Account application(s) 606. This application 606 provides all of the functionalities associated with enabling each user Un to manage his/her system credit account.
4. Social Network application(s) 608. This application provides all of the functionalities associated with developing, launching, executing, maintaining, organizing, delivering, and otherwise providing a social network platform to the users Un.
5. Data input applications(s) 610. This application may receive any type of input data from any user Un, application, system and/or source such as the application 200, the mobile device 300, external systems 400, other sources and any combination thereof.
6. Data output applications(s) 612. This application may output any type of output data to any application, system and/or source such as the application 200, the mobile device 300, external systems 400, any other source and any combination thereof.
7. Miscellaneous application(s) 614. These applications 614 provides all of the other functionalities associated with the system 10.

The applications 600 also may include other applications and/or auxiliary applications (not shown). Those of ordinary skill in the art will appreciate and understand, upon reading this description, that the above list of applications is meant for demonstration and that the system 10 may include other applications that may be necessary for the system 10 to generally perform its functionalities as described in this specification. In addition, as should be appreciated, embodiments or implementations of the system 10 need not include all of the applications listed, and that some or all of the applications may be optional. It is also understood that the scope of the system 10 is not limited in any way by the applications that it may include.

In some embodiments, the database(s) 700 may include one or more of the following databases:
1. Messaging System database(s) 702. This database may store any data and/or other types of information related to and/or required by the messaging system application 602.
2. Wager Management database(s) 704. This database may store any data and/or other types of information related to and/or required by the wager management application 604.
3. User System Credit Account database(s) 706. This database may store any data and/or other types of information related to and/or required by the user system credit account application 606.
4. Social Network database(s) 708. This database may store any data and/or other types of information related to and/or required by the social network application 608.
5. Miscellaneous database(s) 710. This database may store any data and/or other types of additional information related to and/or required by the system 10 such as user profile information, system checks information, and any other type of information for the system 10.

It is understood that the above list of databases is meant for demonstration and that the system 10 may include some or all of the databases, and also may include additional databases as required. It is also understood that the scope of the system 10 is not limited in any way by the databases that it may include.

Various applications 600 and databases 700 in the online wager system 10 may be accessible via interface(s) 106. These interfaces 106 may be provided in the form of APIs or the like and made accessible to users Un via one or more gateways and interfaces 108 (e.g., via a web-based application 200 and/or a mobile application 200 running on a user's device 300).

It is understood that any aspect and/or element of any of embodiment of the system 10 described herein or otherwise may be combined with any other aspect and/or element of any other embodiment(s) to form additional embodiments of the system 10 that are all within the scope of the system 10.

Those of ordinary skill in the art will appreciate and understand, upon reading this description, that embodiments hereof may provide different and/or other advantages, and that not all embodiments or implementations need have all advantages.

### Computing

The services, mechanisms, operations, and acts shown and described above are implemented, at least in part, by software running on one or more computers or computer systems or devices. It should be appreciated that each user device is, or comprises, a computer system.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

FIG. 5 is a schematic diagram of a computer system 800 upon which embodiments of the present disclosure may be implemented and carried out.

According to the present example, the computer system 800 includes a bus 802 (i.e., interconnect), one or more processors 804, one or more communications ports 814, a main memory 806, removable storage media 810, read-only memory 808, and a mass storage 812. Communication port(s) 814 may be connected to one or more networks by way of which the computer system 800 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 804 can be (or include) any known processor, such as, but not limited to, an Intel® Itanium® or Itanium 2® processor(s), AMD® Opteron® or Athlon MP® processor(s), or Motorola® lines of processors, and the like. Communications port(s) 814 can be any of an RS-232 port for use with a modem-based dial-up connection, a 10/100 Ethernet port, a Gigabit port using copper or fiber, or a USB port, and the like. Communications port(s) 814 may be chosen depending on a network such as a Local Area Network (LAN), a Wide Area Network (WAN), a CDN, or any network to which the computer system 800 connects. The computer system 800 may be in communication with peripheral devices (e.g., display screen 816, input device(s) 818) via Input/Output (I/O) port 820. Some or all of the peripheral devices may be integrated into the computer system 800, and the input device(s) 818 may be integrated into the display screen 816 (e.g., in the case of a touch screen).

Main memory 806 can be Random Access Memory (RAM), or any other dynamic storage device(s) commonly known in the art. Read-only memory 808 can be any static storage device(s) such as Programmable Read-Only Memory (PROM) chips for storing static information such as instructions for processor(s) 804. Mass storage 812 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 802 communicatively couples processor(s) 804 with the other memory, storage and communications blocks. Bus 802 can be a PCI/PCI-X, SCSI, a Universal Serial Bus (USB) based system bus (or other) depending on the storage devices used, and the like. Removable storage media 810 can be any kind of external hard-drives, floppy drives, IOMEGA® Zip Drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g., sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements that are appropriate to perform the methods.

As shown, main memory 806 is encoded with application(s) 822 that support(s) the functionality as discussed herein (an application 822 may be an application that provides some or all of the functionality of one or more of the mechanisms described herein). Application(s) 822 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 804 accesses main memory 806 via the use of bus 802 in order to launch, run, execute, interpret or otherwise perform the logic instructions of the application(s) 822. Execution of application(s) 822 produces processing functionality of the service(s) or mechanism(s) related to the application(s). In other words, the process(es) 824 represents one or more portions of the application(s) 822 performing within or upon the processor(s) 804 in the computer system 800.

It should be noted that, in addition to the process(es) 824 that carries(carry) out operations as discussed herein, other embodiments herein include the application 822 itself (i.e., the un-executed or non-performing logic instructions and/or data). The application 822 may be stored on a computer readable medium (e.g., a repository) such as a disk or in an optical medium. According to other embodiments, the application 822 can also be stored in a memory type system such as in firmware, read only memory (ROM), or, as in this example, as executable code within the main memory 806 (e.g., within Random Access Memory or RAM). For example, application 822 may also be stored in removable storage media 810, read-only memory 808, and/or mass storage device 812.

Those skilled in the art will understand that the computer system 800 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware, or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A computer-implemented method comprising:
(A) receiving a first electronic deposit of a first amount of first currency from a first user into a first user account and a second electronic deposit of a second amount of second currency from a second user into a second user account;
(B) by one or more computer systems, converting the first amount of first currency to a first amount of system credits in the first user account and the second amount of second currency to a second amount of system credits in the second user account;
(C) by the one or more computer systems, receiving a request from a first user to send an electronic message to one or more second users including information regarding a wager pertaining to a hypothetical outcome of an event, the information including a wager amount, wager criteria, and an invitation to participate in the wager with the first user;
(D) by the one or more computer systems, receiving the information regarding the wager from the first user;
(E) by the one or more computer systems, comparing the first amount of system credits to the wager amount to determine if the first amount of system credits is equal to or greater than the wager amount;
(F) by the one or more computer systems, upon a determination that the first amount of system credits is equal to or greater than the wager amount:
(G) deducting a first amount of wagered credits equal to the wager amount from the first amount of system credits and placing the first amount of wagered credits into a holding account; and
(H) sending the electronic message to the one or more second users, the electronic message including at least some of the information and a first selectable user interface element, wherein selection of the first selectable user interface indicates an acceptance of the invitation;
(I) by the one or more computer systems, receiving an indication of a selection of the first selectable user interface element by a first one or more second users;
(J) by the one or more computer systems, comparing the second amount of system credits to the wager amount to determine if the second amount of system credits is equal to or greater than the wager amount;
(K) by the one or more computer systems, upon a determination that the second amount of system credits is equal to or greater than the wager amount:
(L) deducting a second amount of wagered credits equal to the wager amount from the second amount of system credits and placing the second amount of wagered credits into the holding account; and
(M) adding the first one or more second users to the wager with the first user.

2. The computer-implemented method of claim 1 further comprising:
(N) receiving an outcome of the event;
(O) based at least in part on the wager criteria and the outcome of the event, by the one or more computer systems, determining an outcome of the wager;
(P) based at least in part on the outcome of the wager, transferring an amount of credits equal to twice the wager amount from the holding account into the first user account or into the second user account.

3. The computer-implemented method of claim 1 wherein the electronic message includes at least one of a new electronic message, a reply to an electronic message, a comment to an electronic message, and a share of an electronic message.

4. The computer-implemented method of claim 1 wherein the electronic message includes at least one of a post on a feed and/or timeline, a post on a message board, and a direct message.

5. The computer-implemented method of claim 1 further comprising:
(I)(1) by the one or more computer systems, upon receiving the indication of a selection of the first selectable user interface element by the first one or more second users, providing an electronic dialogue to the first one or more second user including a second selectable user interface element, wherein selection of the second selectable user interface element confirms that the first one or more second users intended to select the first selectable user interface element.

6. The computer-implemented method of claim 1 where the information further includes at least one of a wager type, names of one or more players upon which the wager is based, player placement information upon which the wager is based, event name upon which the wager is based, date of the event, time left to place wager, wager results release date, and usernames of the first user and the one or more second users who have accepted the wager.

7. The computer-implemented method of claim 1 wherein the wager includes a first wager between the first user and the first one or more second users only.

8. The computer-implemented method of claim 1 wherein the wager includes a first wager between the first user and any number of one or more second users.

9. The computer-implemented method of claim 1 wherein the wager includes a first wager including a first bet that a first player will place higher in a first event than a second player.

10. The computer-implemented method of claim 1 wherein the wager includes a first wager including a first bet that a first player will place higher, lower, or exactly at a first defined finishing position in a first event.
